(19) United States
(12) Patent Application Publication
(10) Pub. No.: US 2023/0380628 A1
(43) Pub. Date: Nov. 30, 2023

(54) DEVICES FOR CLEANING A GRILL GRATE

(71) Applicant: Paul Bertorelli, Nahant, MA (US)

(72) Inventor: Paul Bertorelli, Nahant, MA (US)

(21) Appl. No.: 18/296,590

(22) Filed: Apr. 6, 2023

Related U.S. Application Data
(60) Provisional application No. 63/365,394, filed on May 26, 2022.

(51) Int. Cl. A47J 37/07; A46B 5/00; A46B 9/02; A46B 9/00

(52) U.S. Cl. CPC A47J 37/0786; A46B 5/0012; A46B 5/0091; A46B 9/026; A46B 5/0033; A46B 9/005; A46B 2200/3033; A46B 2200/3093

(57) ABSTRACT

Various grill brushes and corresponding methods of use are disclosed. These grill brushes improve the effectiveness of use compared to existing designs. In certain variations, a wire brush is disclosed that includes a brush wire frame, multiple brush bristles coupled to the brush wire frame, and one or more donut brushes that are mounted on the brush bristles.

### CROSS-REFERENCE TO RELATED APPLICATION

This application claims the benefit of priority of U.S. provisional application No. 63/365,394, filed May 26, 2022, the contents of which are herein incorporated by reference.

### BACKGROUND OF THE INVENTION

The present invention relates to grill brushes and, more particularly, to improved designs of grill brushes.

Prior to the present invention, there was no easy safe way to clean an outdoor grill cooking grate. Prior art products can leave metal bristles on cooking surfaces that may be ingested. If they are not formed from metal, their use can be limited by temperature (i.e., can't be used at high temperatures), meaning they can't be used when the grill is too hot. Further, current metal bristle designs are not effective at thoroughly cleaning grill grates.

As can be seen, there is a need for improved grill brushes as detailed herein.

### SUMMARY OF THE INVENTION

In one aspect of the present invention, a wire brush is disclosed that includes: a brush wire frame; a plurality of brush bristles coupled to the brush wire frame; and one or more donut brushes mounted on the plurality of brush bristles.

In another aspect of the present invention, a method of cleaning a grill grate is disclosed, with the method including the steps of: providing the directly above-described wire brush; and repositioning the one or more donut brushes to respectively engage in one or more openings in the grill grate.

In another aspect of the present invention, a pin brush comprises an elongated handle; a brush head formed at an end of the elongated handle comprising a cylindrical housing; and a plurality of spring-biased scraping pins mounted within the cylindrical housing. The spring-biased scraping pins are operative to extend from the housing in a resting position and to retract into the housing when pressed against a surface.

In yet another aspect of the present invention, a grill cleaner comprises a planar base having a handle mounted to a first surface thereof, parallel to and spaced from the first surface; and a cleaning component comprising a metal plate mounted to a second surface thereof, opposite the first surface.

These and other features, aspects and advantages of the present invention will become better understood with reference to the following drawings, description, and claims.

### BRIEF DESCRIPTION OF THE DRAWINGS

The following figures are included to illustrate certain aspects of the present disclosure and should not be viewed as exclusive embodiments. The subject matter disclosed is capable of considerable modifications, alterations, combinations, and equivalents in form and function, without departing from the scope of this disclosure.

FIG. 1 is a top perspective view of a first embodiment of the present invention, illustrating a grill brush with spring-loaded pins.

FIG. 2 is a detail bottom perspective view of the first embodiment of the present invention.

FIG. 3 is a detail perspective view of the first embodiment of the present invention, illustrating a pin assembly.

FIG. 4 is an exploded perspective view of the pin assembly of FIG. 3.

FIG. 5 is a detail perspective view of the first embodiment of the present invention, with parts shown in cross-section, indicated by line 5-5 of FIG. 2.

FIG. 6 is a detail side elevation view of the first embodiment of the present invention, in use.

FIG. 7 is a perspective view of a second embodiment of the present invention.

FIG. 8 is a detail perspective view of the clamping of the second embodiment of the present invention.

FIG. 9 is an exploded perspective view of the second embodiment of the present invention.

FIG. 10 is a front elevation view of the second embodiment of the present invention, with pins thereof shown in an inactive, just before use position.

FIG. 11 is a front elevation view of the second embodiment of the present invention, with the pins shown in a functioning, in use position.

FIG. 12 is a flowchart illustrating a novel process associated with the second embodiment of the present invention.

FIG. 13 is a perspective view of a third embodiment of the present invention.

FIG. 14 is a front detail view of positionable round donut brushes of the third embodiment in a first orientation.

FIG. 15 is a front detail view of the positionable round donut brushes of the third embodiment in a second orientation.

FIG. 16 is a flow is a flowchart illustrating a novel process associated with the third embodiment of the present invention.

FIG. 17 is a detail perspective view of one donut of the third embodiment of the present invention.

FIG. 18 is a detail perspective view of the third embodiment of the present invention, showing the donut of FIG. 17 being added to an alternative brush configuration.

FIG. 19 is a section view of the third embodiment of the present invention, taken along line 19-19 in FIG. 18.

FIG. 20 is a perspective view of the third embodiment of the present invention, showing the donut of FIG. 17 being moved into position on the alternative brush configuration.

FIG. 21 is a detail perspective view of a fourth embodiment of the present invention, with a portion of a handle thereof removed.

FIG. 22 is a front view of the fourth embodiment of the present invention.

FIG. 23 is an exploded view of the fourth embodiment of the present invention.

FIG. 24 is a section view of the fourth embodiment of the present invention, taken along line 24-24 in FIG. 21.

FIG. 25 is a detail perspective view of a fifth embodiment of the present invention, illustrating addition of a spring to a brush.

FIG. 26 is another detail perspective view thereof, with the spring in place.

FIG. 27 is a perspective view of a sixth embodiment of the present invention, with the spring installed on a scraper bar.

FIG. 28 is a detail perspective view thereof.

FIG. 29 is a detail side elevation view thereof.

FIG. 30 is a perspective view of a seventh embodiment of the present invention.

FIG. 31 is a sectional view thereof, taken along line 31-31 in FIG. 30.

FIG. 32 is an exploded view thereof.

FIG. 33 is a perspective view of an eighth embodiment of the present invention.

FIG. 34 is an exploded view thereof.

FIG. 35 is a perspective view of a ninth embodiment of the present invention.

FIG. 36 is a sectional view thereof, taken along line 36-36 in FIG. 35.

FIG. 37 is another sectional view thereof, illustrating adjustment of a pin in use on a grill grate.

FIG. 38 is an exploded view thereof.

FIG. 39 is a top perspective view of a tenth embodiment of the present invention.

FIG. 40 is a bottom perspective view thereof.

FIG. 41 is a top plan view thereof.

FIG. 42 is a side elevation view thereof.

FIG. 43 is an exploded view thereof.

FIG. 44 is a bottom perspective view of an eleventh embodiment of the present invention.

FIG. 45 is a bottom plan view thereof.

FIG. 46 is a bottom perspective view of a twelfth embodiment of the present invention.

FIG. 47 is a front elevation view thereof.

FIG. 48 is a bottom perspective view of a thirteenth embodiment of the present invention.

### DETAILED DESCRIPTION OF THE INVENTION

The subject disclosure is described with reference to the drawings, wherein like reference numerals are used to refer to like elements throughout. In the following description, for purposes of explanation, numerous specific details are set forth in order to provide a thorough understanding of the present disclosure such that one skilled in the art will be enabled to make and use the present invention. It may be evident, however, that the present disclosure may be practiced without some of these specific details. For the purpose of clarity, technical material that is known in the technical fields related to the present invention has not been described in detail so that the present invention is not unnecessarily obscured.

Broadly, an embodiment of the present invention provides a grill brush that better cleans a grill than previous designs.

Certain embodiments of the present invention include a spring-loaded brush. It can be any shape. Spring-loaded pins may be provided and can be round, square, hexagonal, or star shaped. A scraping end of the pins may have a planar tip, a pointed tip, or a concave tip, for example. In certain embodiments, the pins extend one-quarter inch past the spring pin housing. When the spring pin brush is used on a grate, because of the springs, the cleaning device forms to the grate's surfaces and cleans equally on the top and sides of the grate. Embodiments of the present invention will not leave metal bristles on the cooking surface and can be used at any temperature.

In some embodiments, a brush handle component may couple to a brush head component by way of mating threads. In other embodiments, components may snap or clip together.

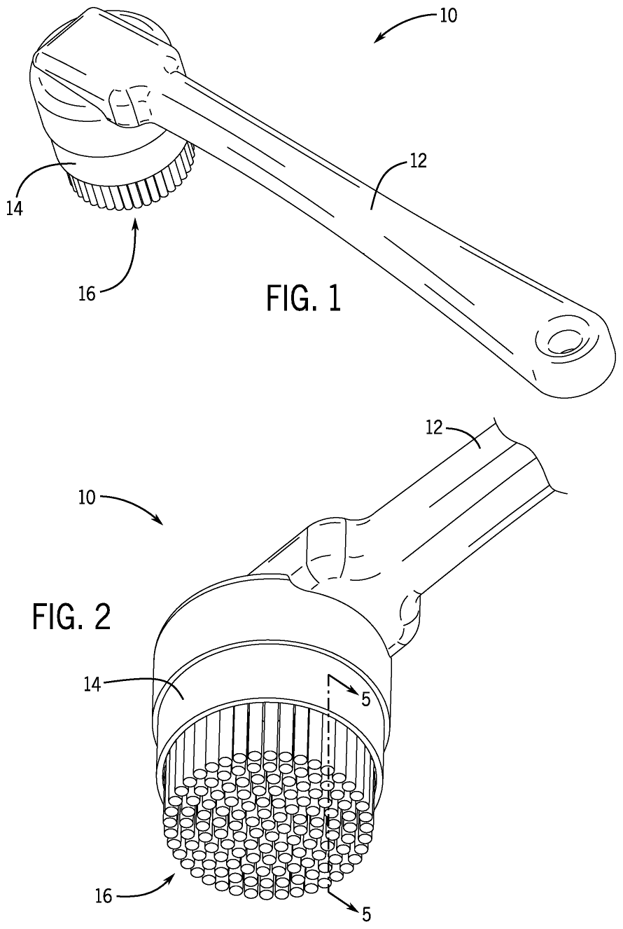

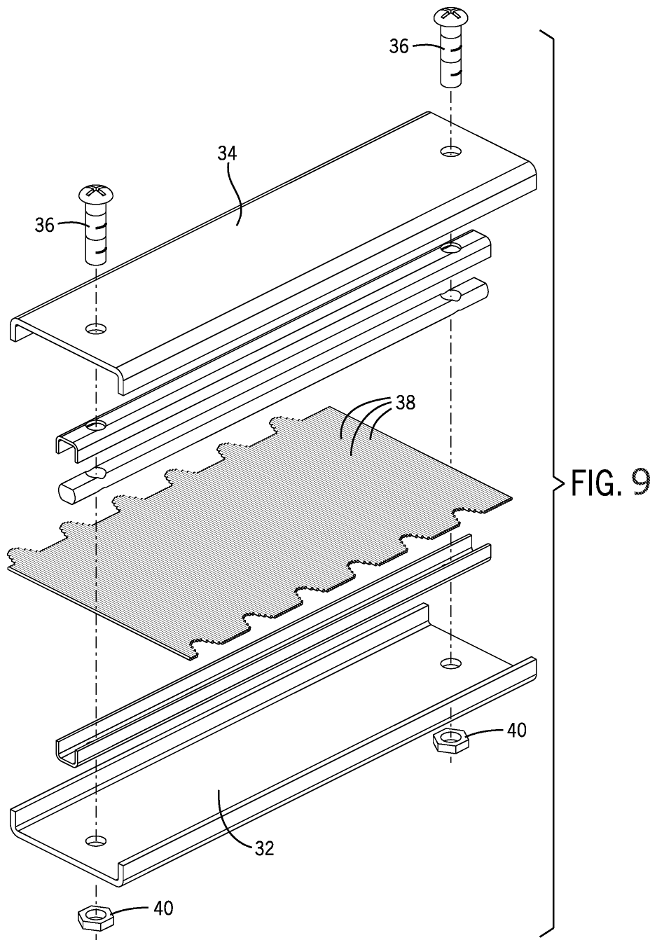

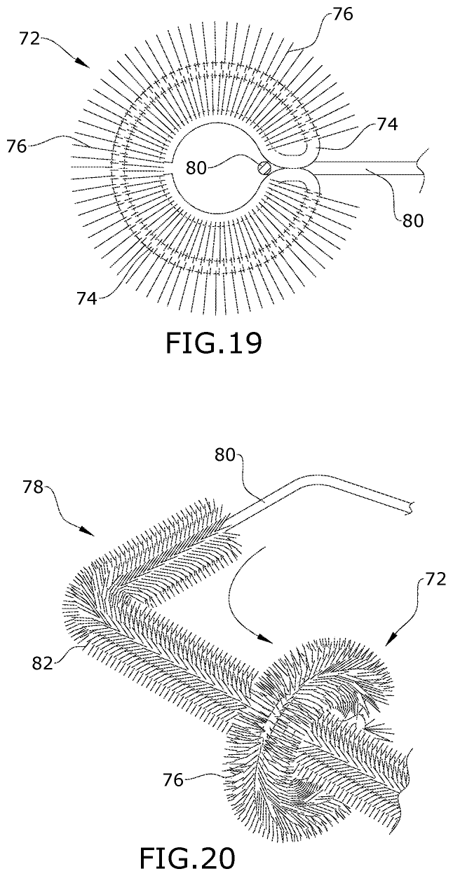

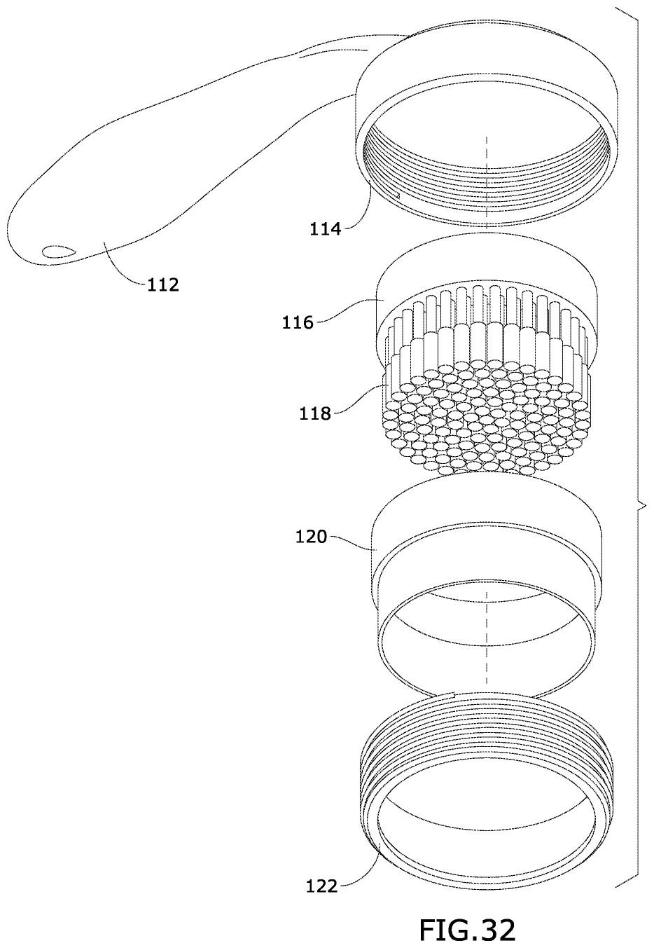

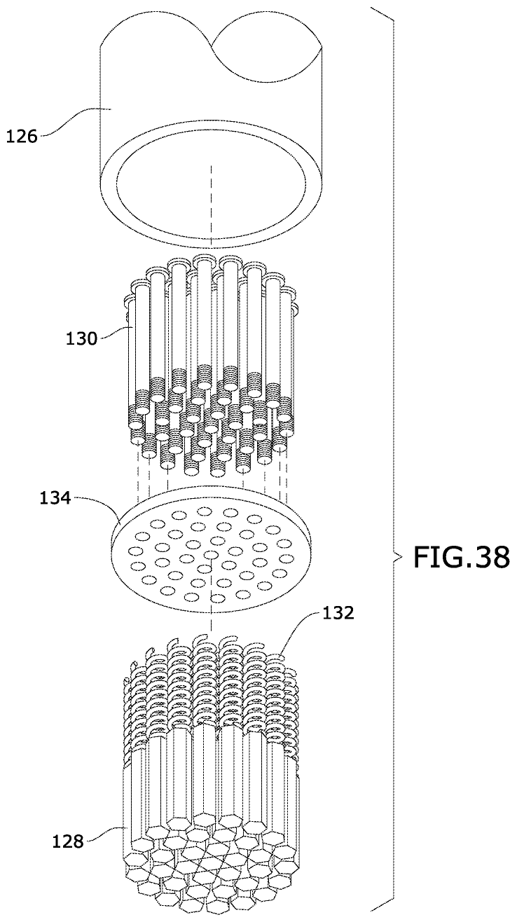

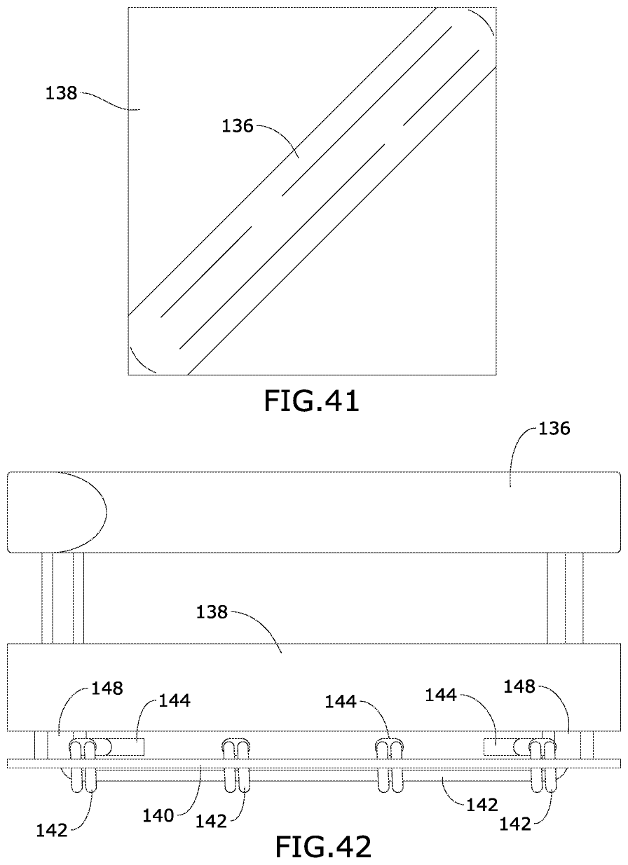

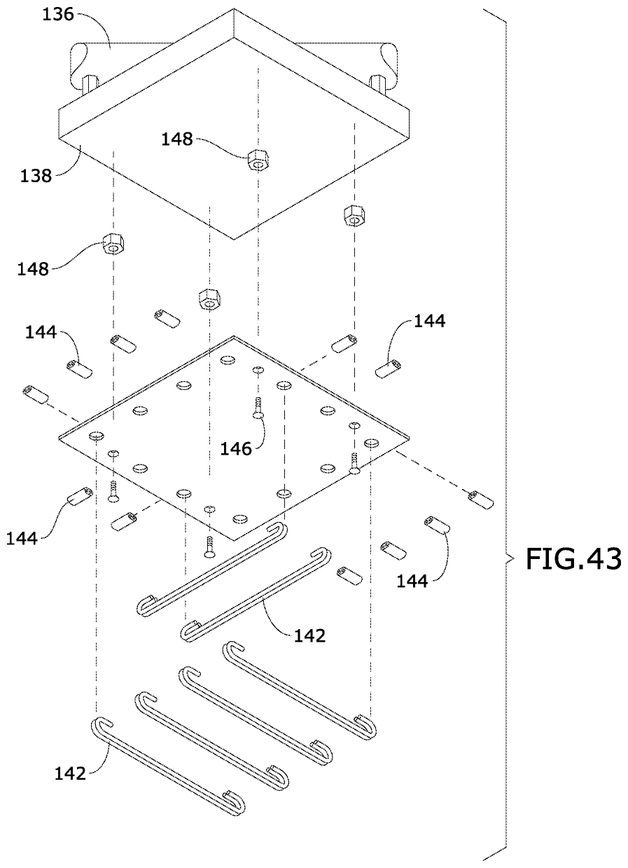

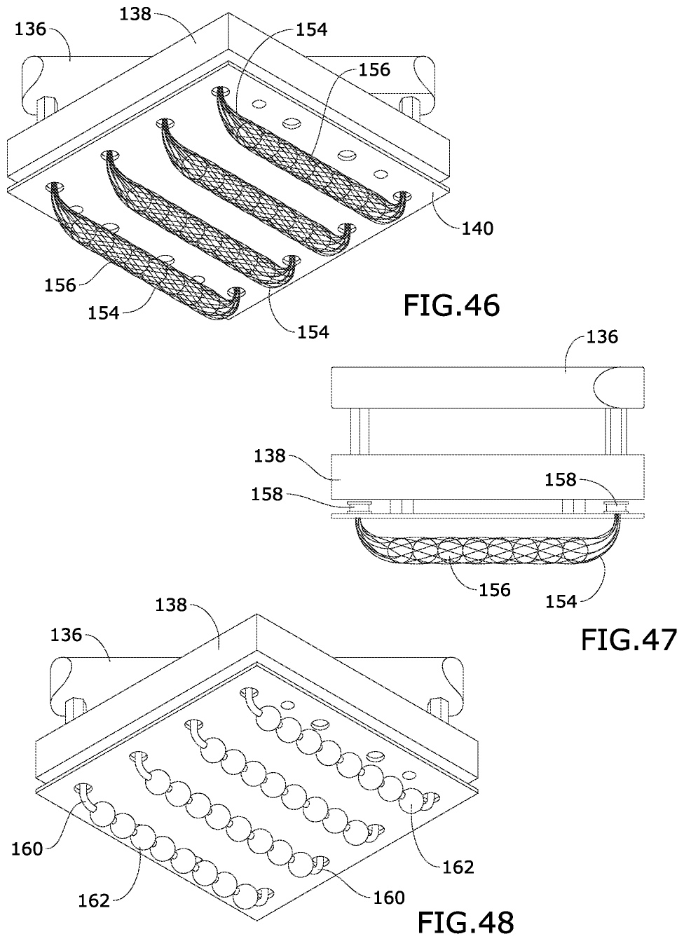

Referring now to FIGS. 1-48, embodiments of the present invention may include the following:
10: is the overall grill brush with spring-loaded pins invention (first embodiment).
12: is the handle.
14: is the spring pin housing.
16: are the spring-loaded pins.
16A: is a pin.
18: is the pin assembly.
20: are the springs.
22: are the spring retaining rods.
24: is the grill grate.
30: is the overall clamp grill brush embodiment of the invention (second embodiment).
32: is the rear clamp half.
34: is the front clamp half.
36: are the fasteners.
38: are the pins.
40: are the nuts.
50: is the flowchart.
60: is the dual-brush embodiment of the invention (third embodiment).
62: is the handle of the dual-brush embodiment.
64: is the wire frame.
66: is the single row round wire brush.
68: are the positionable round donut brushes (forming a set).
70: is the block diagram of the third embodiment.
72: is the individual donut brush.
74: is the wire frame.
76: are the bristles.
78: is the brush.
80: is the wire frame.
82: are the bristles.
84: is the chainmail brush (fourth embodiment).
86: is the chainmail bag.
88: is the washer.
90: is the screw.
92: is the washer holding washer.
94: is the shield cup.
96: are the ball bearings.
98: are the nuts.
100: is the handle.
102: is the handle washer.
104: are round springs.
106: is a scraper arbor.
108: is a scraper rod.
110: are scraping blades.
112: is a handle of a fifth and a sixth embodiment of a grill brush.
114: is a threaded head.
116: is a pin base.
118, two-piece pins.
120: is a pin sleeve.
122: is a threaded retainer.
124, one-piece pins.
126: is a scraper housing of a seventh embodiment of a grill brush.
128: are scraping pins.
130: are upper pins.
132: are springs.
134: is a pin plate.
136: is a block handle of an eighth, a ninth, a tenth, and an eleventh embodiment of a grill brush.
138: is a block.
140: is a plate.
142: are scraping wires or wire rope.
144: are crimp sleeves.
146: are screws.
148: are spacers.
150: are wire brush rods or twisted wires.
152: are twisted in wire brushes.
154: is a wire or cable sock brush.
156: are ball bearings.
158: are crimp sleeves.
160: are rods.
162: are ball bearings.

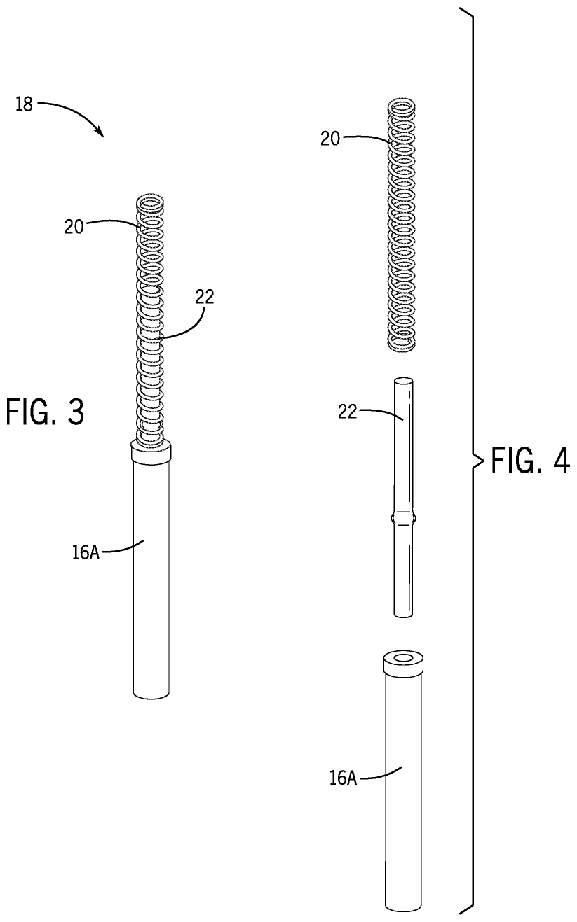

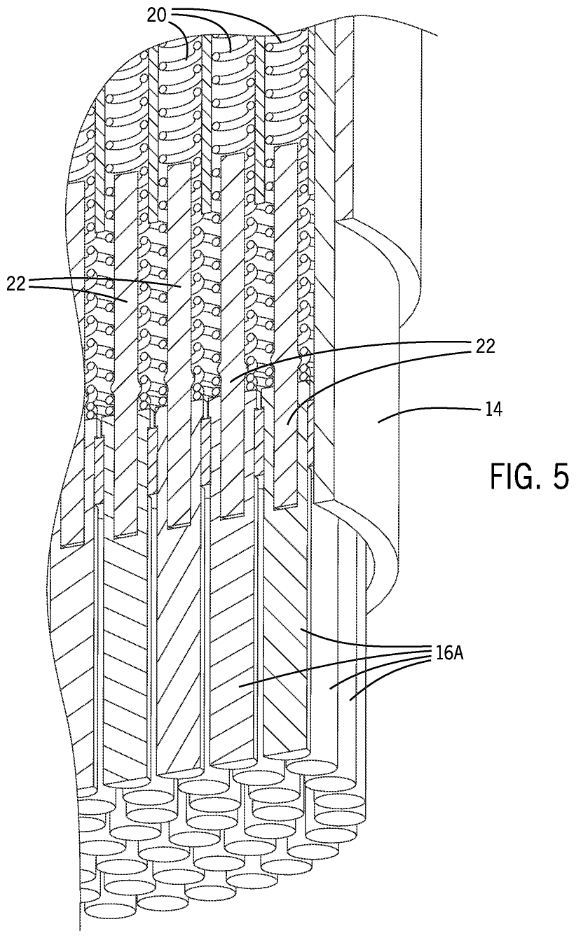

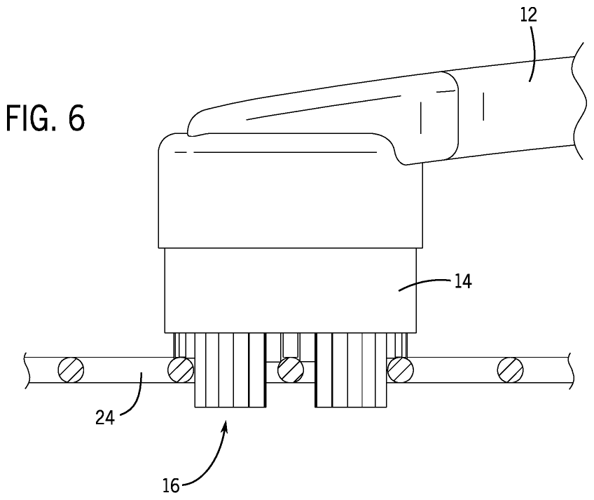

As shown in FIGS. 1-6, the first embodiment 10, sometimes referred to herein as a “spring-biased pin brush”, includes an elongated handle 12, a cylindrical spring pin housing 14 provided at an end of the handle, and a set 16 of spring-loaded pin assemblies 18. As shown in FIGS. 3 and 4, each pin assembly 18 includes a pin or pin end 16A, a spring retaining rod 22 inserted into or joined to and extending from the pin 16A, and a spring 20 biasing the pin 16A. In some instances, the retaining rod 22 and the pin 16A may be integrally formed. The retaining rod may have a ridge operative to retain the spring against the pin end. Each spring 20 is positioned in the spring pin housing 14 and biases each pin 16A outwardly therefrom, as shown in FIG. 5. As illustrated in FIG. 6, engagement with a grill grate 24 urges certain pins 16A of the set 16 upwardly into the housing 14, thus contouring itself to the surface it is applied to, in order to brush the grate 24 (including the top and the sides of the grate sections) clean. It is further noted that, while the pin 16 is depicted as having a larger outer diameter at an upper end thereof, in certain embodiments, the outer diameter may be embodied as continuous the entire length of the pin 16A (i.e., no “ledge” needs to be formed on it).

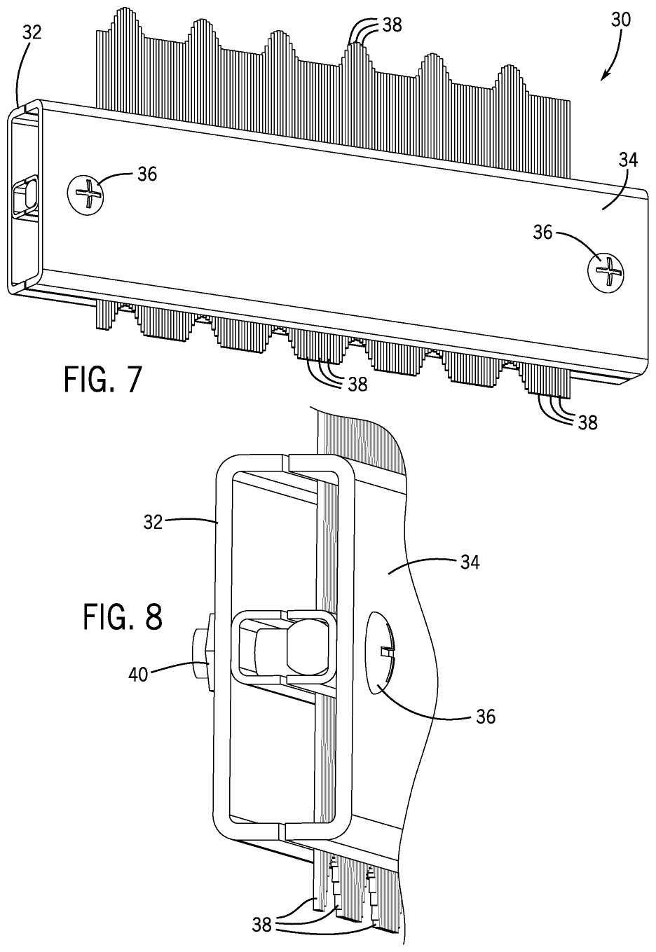

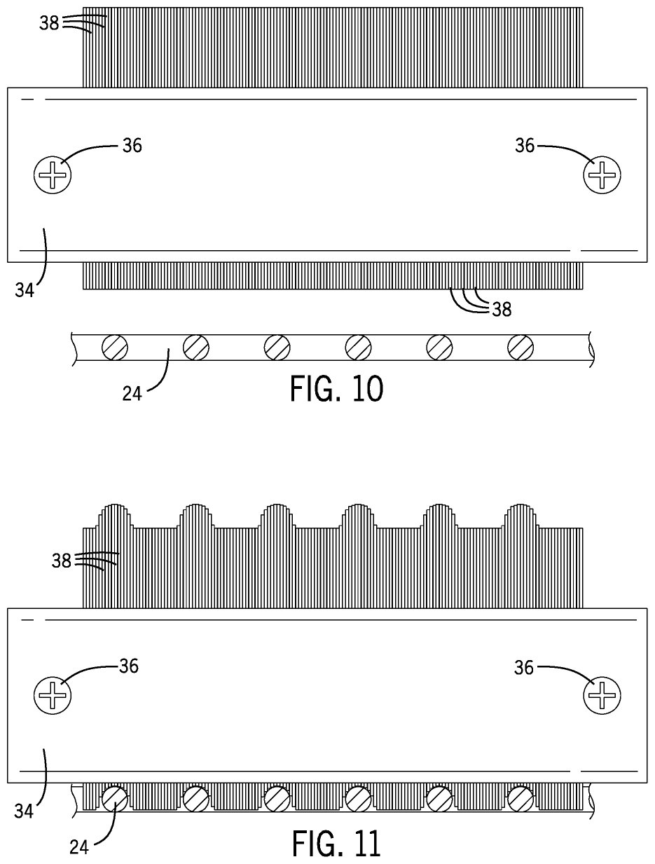

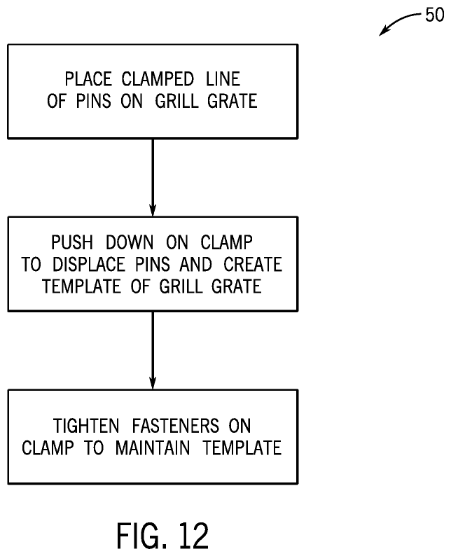

As shown in FIGS. 7-12, a second embodiment 30, sometimes referred to herein as a “clamp brush”, includes a rear clamp half 32 and a front clamp half 34 coupled together via fasteners 36 and nuts 40. Disposed therebetween are pins 38, which are held in place by a compression force applied thereto by the clamp halves 32, 34. As shown in FIGS. 10 and 11 and described in FIG. 12, the embodiment 30 can be used to create a custom fit to a user's grill grate 24. Starting off, all the pins 38 are aligned, with the clamp halves 32, 34 loosely fastened. A user presses the embodiment 30 down on the grates 24, which causes certain pins 38 to slide as they contact the grate 24. Once this mold has been made, the fasteners 36 can be tightened with the nuts 40 to maintain the brush 30 in this form for use.

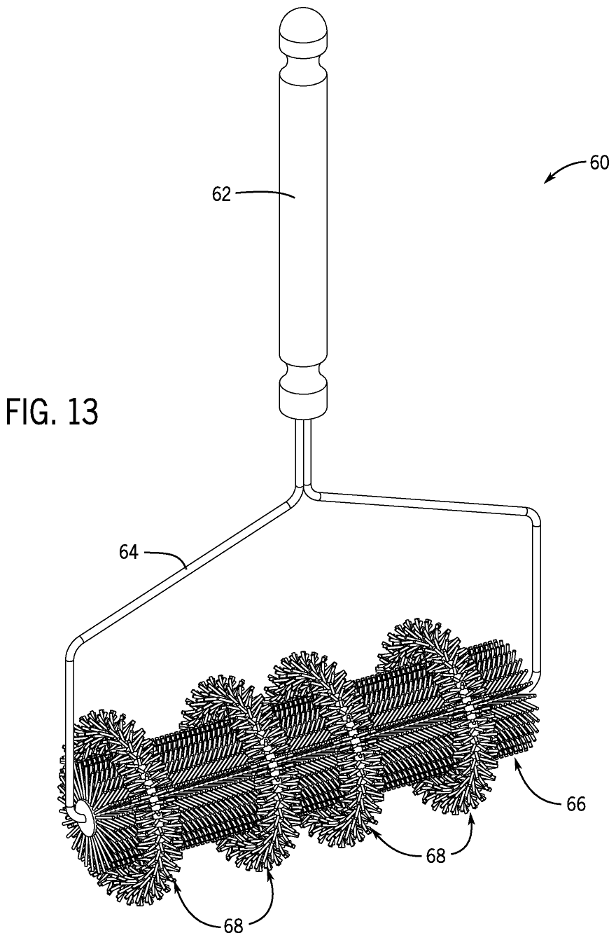

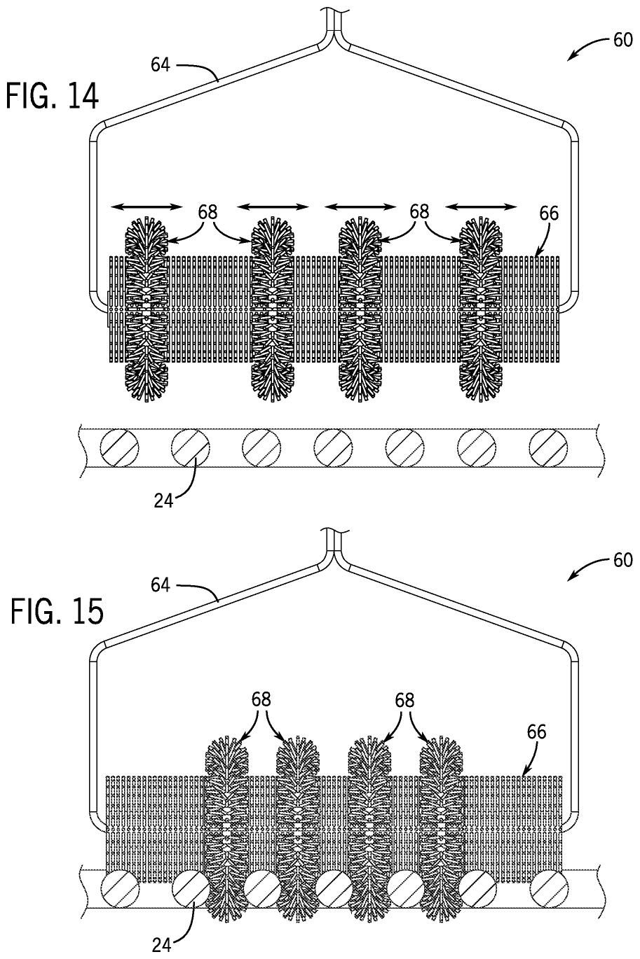

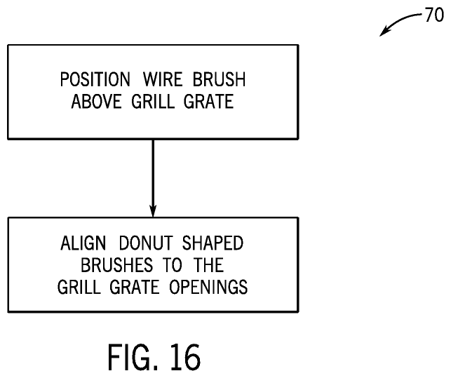

Referring to FIGS. 13-16, a third embodiment 60 of a brush includes a handle 62, a wire frame 64 coupled to the handle 62, a single row wire brush 66 coupled to the wire frame 64, and repositionable toroidal (donut or oval) brushes 68 laterally movable on the round wire brush 66. In certain embodiments, this brush is embodied in the form of a twist-in wire brush. As illustrated in FIGS. 14-15 and described in FIG. 16, the donut brushes 68 can be laterally repositioned to engage in gaps/openings between the grill grates 24, providing a customized cleaning product for the grill.

In certain embodiments, the donut brushes 68 could be provided independently of the brush 66, with various inside and outside diameters. In such embodiments, the donut brushes 68 could be provided in various ways. For example, when the wire frame 64 and single row wire brush 66 is embodied as a twisted-in wire brush, the donut brushes 68 may be inserted over the twisted wire of the handle of the brush 66. Furthermore, the donut brushes 68 may be pushed over a straight, round, wire brush that is commonly used to clean a grill grate 24.

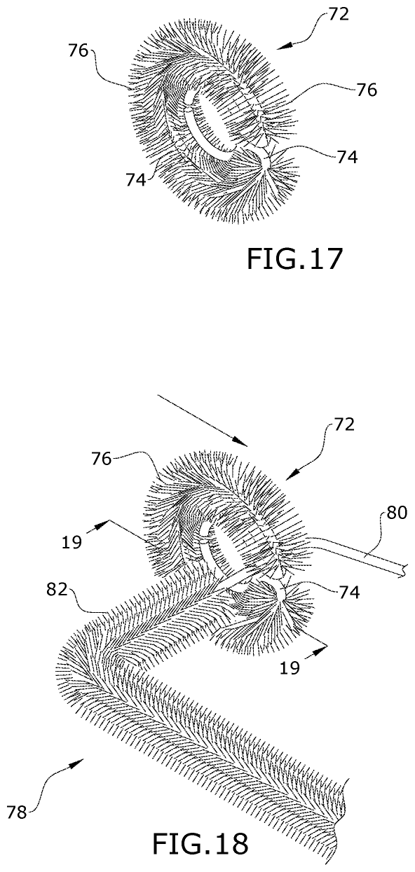

More specifically, and as shown in FIGS. 17-20, a single donut brush 72 (of the plurality of donut brushes 68) may be provided that is formed from a wire frame 74 that forms a C-shape, with bristles 76 wrapped around the wire frame 74, operative to accommodate a wire frame of a brush. FIG. 18 depicts the donut brush 72 being mounted on a twisted-in wire brush 78 that includes a wire frame 80 and bristles 82 twisted thereon. As shown from FIGS. 18 to 20, the donut brush 72 can be easily slid on the wire frame 80 portion of the brush 78 (due to the C-shape design) and then slid down over the bristles 82 into an appropriate position. As previously described in FIGS. 14-15, the donut brush 72 can be laterally repositioned in order to accommodate various shaped/sized grates. Further, and as those with skill in the art will appreciate, the donut brush 72 is equally capable of being mounted to the single row wire brush 66 in the same manner.

In certain embodiments, the donut 72 may be tapered in form. By way of example, one side of the donut 72 may be 20 millimeters thick while the other side is 10 millimeters. Based on the spacing in the grate, the donut 72 can be spun to fit in the gap between the grates.

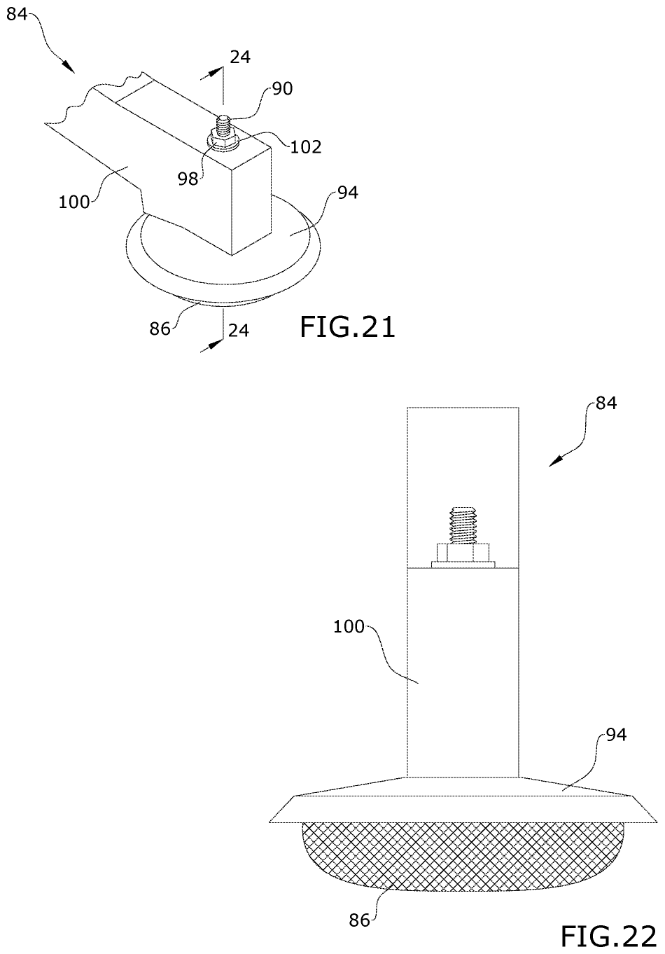

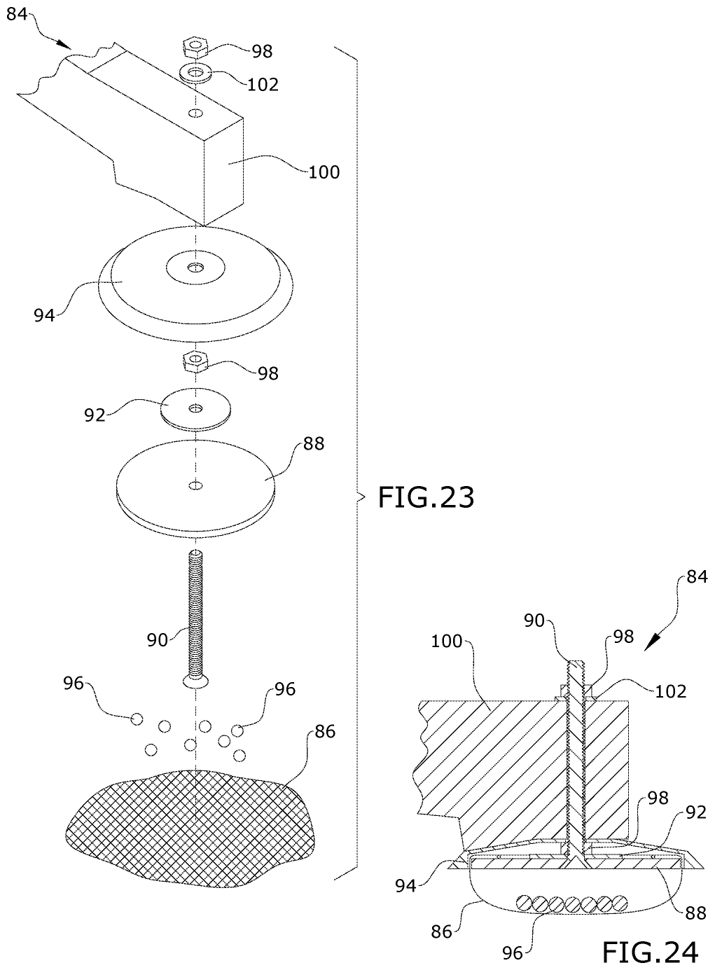

FIGS. 21-24 depict a fourth embodiment of the present invention. Specifically, a chain mail brush 84 includes a chain mail mesh bag 86 that houses a plurality of ball bearings 96 therein. While the particular manner in which the bag 86 may be coupled to a handle 100 may be varied, an exemplary configuration is shown in FIGS. 23-24. As shown, a washer 88, in conjunction with a shield cup 94, can be used to clamp the bag 86 in place. To hold the shield cup 94 and the washer 88 in place against the handle 100, a retention washer 92, handle washer 102, nuts 98, and screw 90 are coupled together in the manner shown in FIG. 24. Thus, the bag 86 is securely held in place, and can be made saggy or tight, as desired. Further, the ball bearings 96 may take various forms, such as solid metal or hollow metal, and can be formed in various shapes, such as round, square, pyramidal, octagonal, etc. Further, in certain embodiments, the shield cup 94 may be omitted depending on the desired sag of the bag 86.

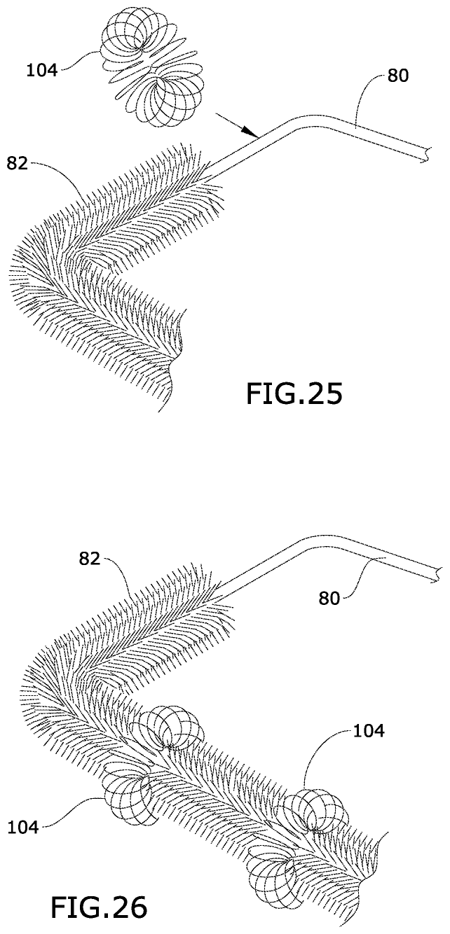

FIGS. 25-26 illustrate a grill brush embodiment comprising one or more round springs 104 installed on a bristle brush such as the class of brushes illustrated in FIG. 18 comprising bristles 82 affixed to a wire frame 80 and protruding radially therefrom. The round springs 104 may be slid onto the wire frame 80 and down over the bristles 82 and laterally repositioned to accommodate various shaped and/or sized grates 24.

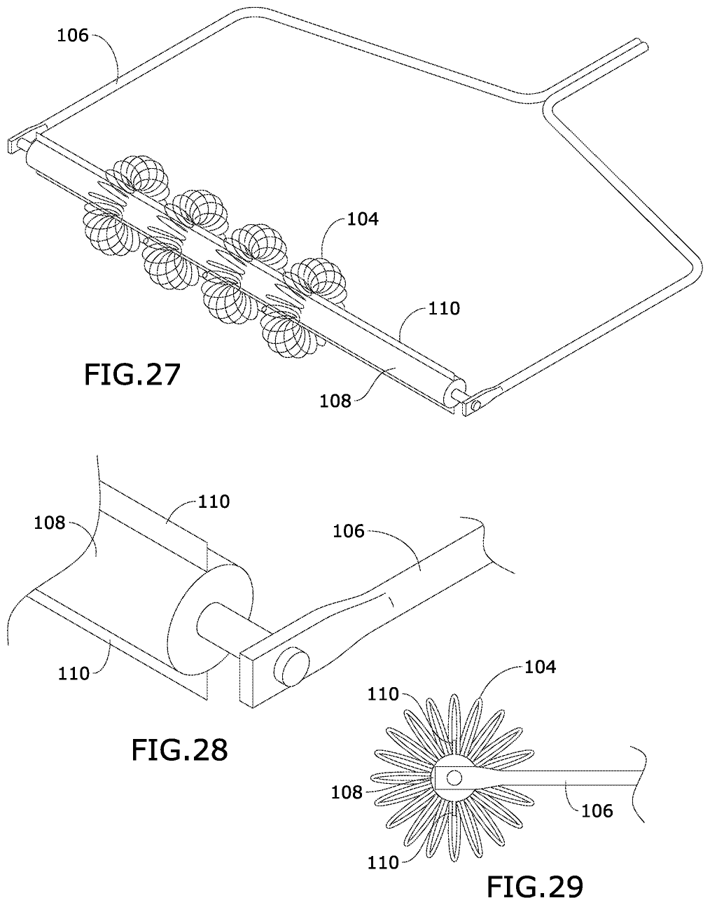

As shown in FIGS. 27-29, the round springs 104 may alternatively be installed on a scraper, such as one of a class comprising a scraper arbor 106 having a scraper rod 108 rotatably mounted thereto, with one or more scraping blades 110 extending longitudinally along the scraper rod 108.

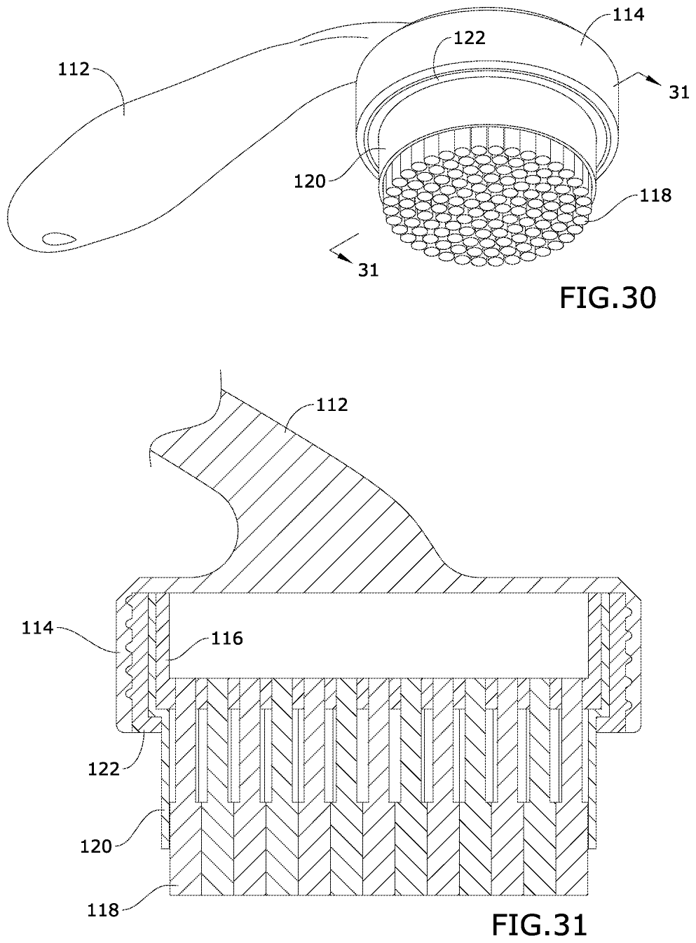

FIGS. 30-32 illustrate another embodiment of a pin brush, comprising a threaded head 114 having a handle 112 extending therefrom and a plurality of two-piece pins 118 slidably mounted in a pin base 116. A first or lower pin portion of the two-piece pins 118 has a diameter accommodated by apertures in the pin base 116, while a second or upper pin portion of the two-piece pins 118 has a wider diameter, forming a shoulder that does not pass through the associated aperture in the pin base 116 apertures. A spring on the lower pin portion is seated against the pin plate. The pin base 116 and pins 118 are secured within the threaded head 114 by a threaded retainer ring 122 mated to the threaded head 114. The retainer ring 122 snugly seats around a pin sleeve 120 which encompasses the pin base 116 and the two-piece pins 118, such that the pins 118 extend beyond the pin sleeve 120 in an extended position. The pins are configured as a parallel array. The pin sleeve 120 has a first portion with an inner diameter the same as or slightly larger than the outer diameter of the pin base 116 and second portion with an inner diameter smaller than the inner diameter of the first portion, configured to align with an outer perimeter of the pins 118. The first portion and the second portion form a shoulder that mates with a shoulder formed in the threaded retainer ring 122, such that the threaded retainer 122 securely retains the pin base 116 and the pin sleeve 120 when coupled with the threaded head 114. The retainer may be operative to retain the pins in an operative configuration within the head.

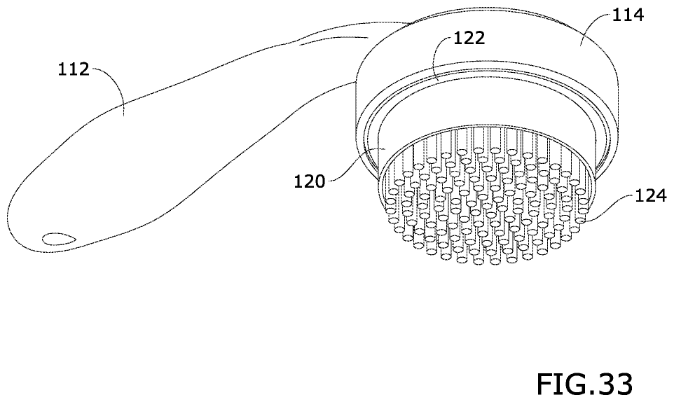

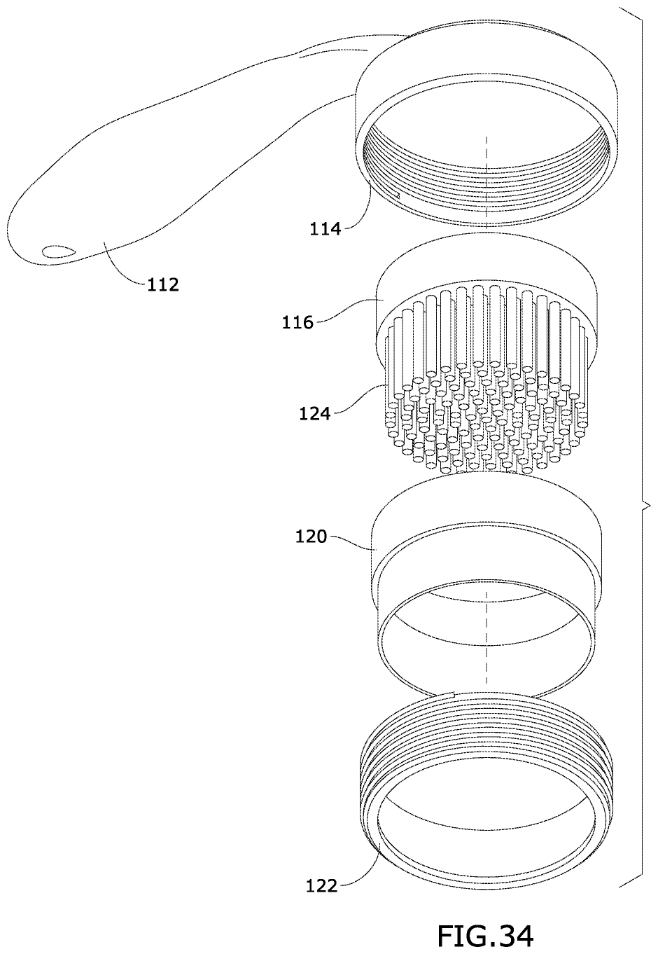

FIGS. 33-34 illustrate yet another embodiment of a pin brush having one-piece pins 124 embedded in the pin base 116. The pin base 116 may be securely retained within the threaded head 114 by the pinsleeve 120 in combination with the threaded retainer ring 122, as discussed above.

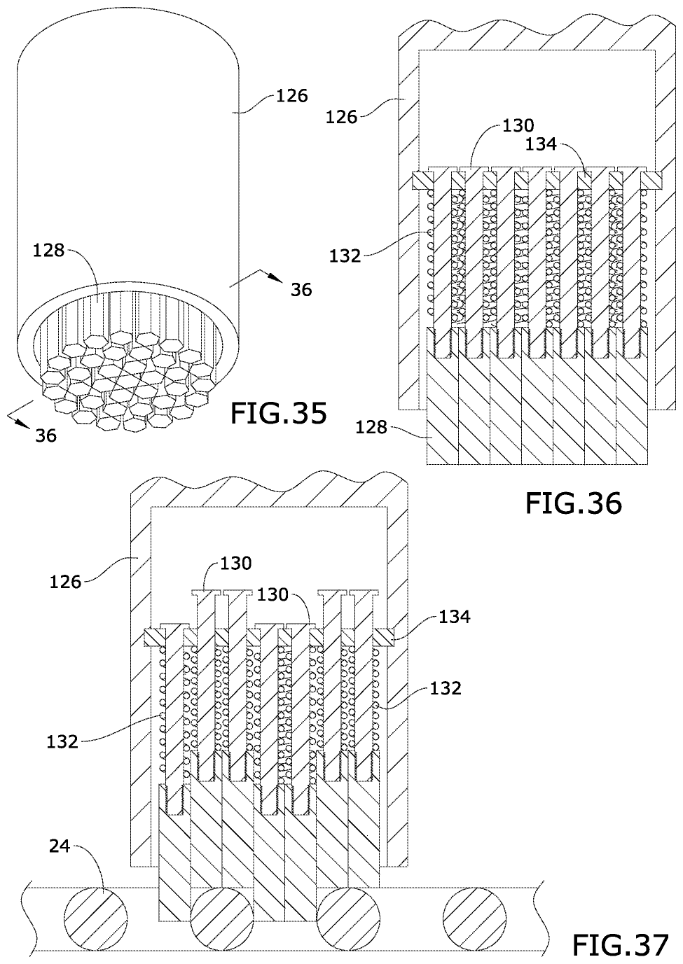

As shown in FIGS. 35-38, another embodiment of a spring-loaded pin brush has a plurality of pin assemblies comprising spring-biased scraping pins 128 mounted to a circular pin plate 134 by threaded upper pins 130, with springs 132 therebetween. The threaded upper pins 130, slidably accommodated by apertures within the pin plate 134, threadedly couple with the scraping pins 128. The pin plate 134 is embedded within a channel formed in an inner sidewall of a housing 126. The scraping pins 128 may have a hexagonal cross section. In use, the brush may be pressed down on a grill grate 24, urging the scraping pins 128 in contact with the grate 24 to retract into the housing 126. Once pressure against the grate 24 is removed, the springs 132 urge the scraping pins 128 into a resting position.

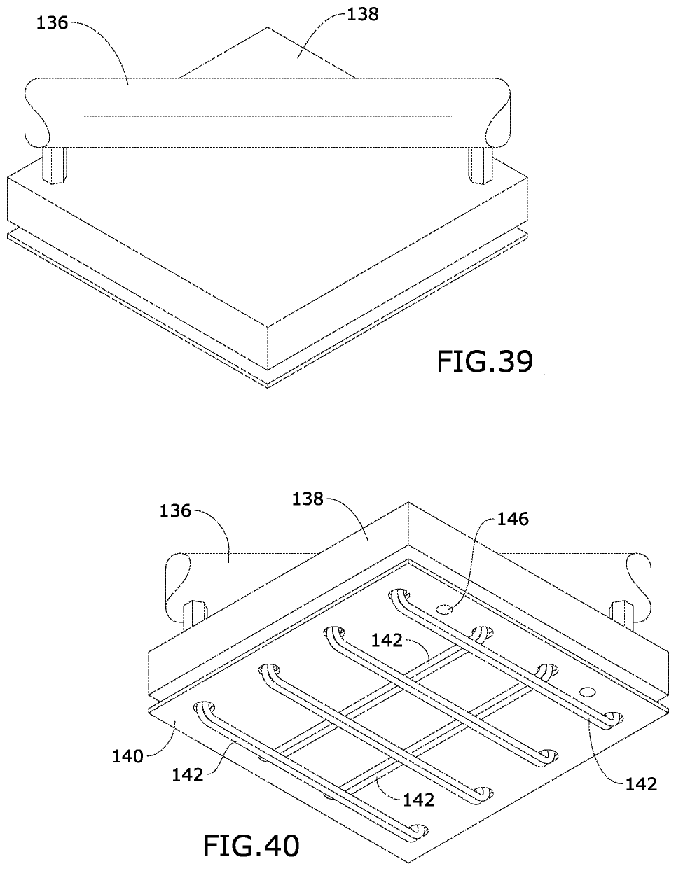

A scraping block or grill cleaner according to other embodiments of the present invention is shown in FIGS. 39-43. While the shape and dimensions of the block 138 are not particularly limited, a square block 138 or planar base is shown having a handle 136 affixed thereto diagonally across a first surface of the block 138. The handle 136 may have legs to space a gripping portion of the handle 136 from the block 138. The handle 136 may also have rounded edges and rounded ends. A plate 140, e.g., a metal plate, may be affixed to a second surface of the block 138, opposite the first surface, with fasteners such as screws 146. The plate 140 may be spaced from the block 138 with spacers 148, such as nuts or washers, and may have a plurality of apertures to accommodate various components. As shown in FIGS. 40, 42, and 43, a grid formed of a plurality of scraping wires 142 may be mounted to the plate 140. The ends of the wires 142 may be covered with crimp sleeves 144 between the block 138 and the plate 140.

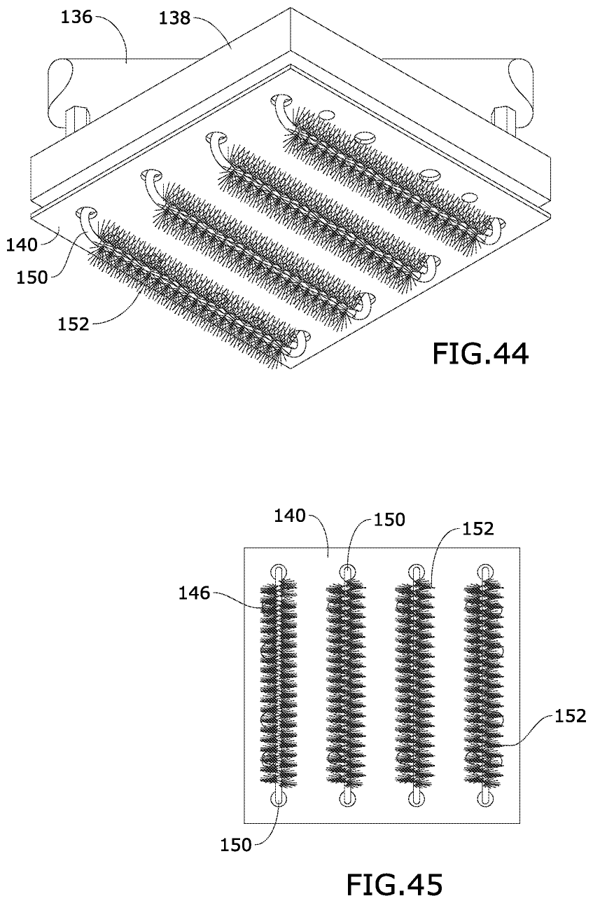

FIGS. 44-45 illustrate an alternative embodiment, with a plurality of wire brushes 152, each formed from bristles affixed to a rod 150, mounted, parallel to one another, to the plate 140. This embodiment is sometimes referred to herein as a blockhead brush with twisted in wire heads 152. The heads 152 ‘float’, i.e., they are not held rigidly in place to the plate 140. Rather the heads 152 may be angled side-to-side, serving as a self-adjusting head that freely adjusts and will gravitate to gaps in a grill surface for superior cleaning. The brush may be used by pushing and sweeping the brush across the grill surface.

In yet another embodiment, a plurality of wire mesh socks 154 may be mounted, parallel to one another, to the plate 140. The wire socks 154 may contain a plurality of ball bearings or metal beads 156. Crimp sleeves 158 serve both to retain the ball bearings 156 as rows within the wire socks 154 and to fasten the wire socks 154 onto the plate 140.

In some embodiments, brush heads may be formed of a cable sock 154 with a stainless-steel wire, e.g., 150, 160 passing longitudinally through, having crimps 158 securing each end. The wire sock 154 may be compressed prior to crimping, such that the cable 150, 160 maintains the wire sock 154 compression and the sock 154 expands in diameter.

As shown in FIG. 48 ball bearings or metal beads 162 may in some cases be mounted to the plate 140, strung or arrayed on rods 160.

While intended primarily for grill use, those with skill will appreciate that the present invention can be used to clean various surfaces.

In an exemplary embodiment, the brushes may be made and assembled as described above and as follows. By way of example, the first embodiment may be formed from pins that are 1.5 inches long with half of one end smaller than the other end to accept a spring. One end of the spring can be epoxied to pipe end cap then the pipe be cut, with the pipe made as long as the pin, 1.5 inches, then placed the narrow end of pins into friction fit spring. The push spring is long enough to allow the pin to move into the vessel ¼ of an inch so that brush can contour to grate.

It will be appreciated by those with skill in the art that all three illustrated embodiments are configured in a way that allows them to form to the shape of the grill. The first two embodiments are very safe, as they do not include bristles in the design. The third embodiment can be adjusted to cover gaps in grid, which allows it to clean top and sides of grill grate. Consequently, it is also a very effective option, albeit slightly less safe to use (as it incorporates bristles in the design).

While one or more preferred embodiments are disclosed, many other implementations will occur to one of ordinary skill in the art and are all within the scope of the invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Other arrangements, methods, modifications, and substitutions by one of ordinary skill in the art are therefore also considered to be within the scope of the present invention, which is not to be limited except by the claims that follow.

While apparatuses and methods are described in terms of “comprising,” “containing,” or “including” various components or steps, the apparatuses and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. The term “substantially” shall be interpreted to mean completely and/or nearly completely. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted. Moreover, the use of directional terms such as above, below, upper, lower, upward, downward, left, right, and the like are used in relation to the illustrative embodiments as they are depicted in the figures, the upward or upper direction being toward the top of the corresponding figure and the downward or lower direction being toward the bottom of the corresponding figure.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. A wire brush comprising:
a brush wire frame;
a plurality of brush bristles coupled to the brush wire frame and protruding radially outward therefrom; and
one or more repositionable toroidal brushes slidably mounted around the plurality of brush bristles.

2. The wire brush of claim 1, wherein each toroidal brush of the one or more toroidal brushes comprises a C-shaped toroidal brush wire frame which forms a gap operative to accommodate the brush wire frame.

3. The wire brush of claim 1, wherein each toroidal brush of the one or more toroidal brushes comprises a plurality of bristles coupled to the brush wire frame and protruding radially outward therefrom.

4. A method of cleaning a grill grate, the method comprising the steps of:
providing the wire brush of claim 1; and
repositioning the one or more toroidal brushes to respectively engage in one or more openings in the grill grate.

5. A pin brush comprising:
an elongated handle;
a brush head formed at an end of the elongated handle comprising a cylindrical housing; and
a plurality of spring-biased scraping pins mounted within the cylindrical housing;
wherein the spring-biased scraping pins are operative to extend from the housing in a resting position and to retract into the housing when pressed against a surface.

6. The pin brush of claim 5, wherein the cylindrical housing comprises a head coupled with a retainer, said retainer being operative to retain the plurality of spring-biased scraping pins in an operative configuration within the head.

7. The pin brush of claim 5, wherein the plurality of spring-biased scraping pins include assemblies having a pin end with a retaining rod joined thereto, said retaining rod having a ridge operative to retain a spring against the pin end such that the spring biases the pin end to extend from the housing.

8. The pin brush of claim 5, wherein the spring-biased scraping pins are configured as a parallel array mounted within a pin base.

9. The pin brush of claim 5, wherein the cylindrical housing has a sidewall and further comprises a circular pin plate mounted to a channel around an interior of the sidewall, said circular pin plate having apertures configured to accommodate the plurality of spring-biased scraping pins; and wherein each of said spring-biased scraping pins comprises an upper pin portion having a head larger than a diameter of an associated aperture threadedly coupled to a lower pin portion having a spring seated against the pin plate.

10. A grill cleaner comprising a planar base having a handle mounted to a first surface thereof, parallel to and spaced from the first surface; and a cleaning component comprising a metal plate mounted to a second surface thereof, opposite the first surface.

11. The grill cleaner of claim 10, wherein the first surface is substantially square and the handle is fastened at diagonal corners of the planar base.

12. The grill cleaner of claim 10, wherein the cleaning component further comprises a wire grid mounted to the metal plate.

13. The grill cleaner of claim 10, wherein the cleaning component comprises wire brush rows mounted tiltably to the metal plate.

14. The grill cleaner of claim 10, wherein the cleaning component comprises ball bearing rows mounted to the metal plate.

15. The grill cleaner of claim 14, wherein the ball bearing rows are contained within wire socks mounted to the metal plate.

16. The grill cleaner of claim 14, wherein the ball bearing rows are arrayed on rods mounted to the metal plate.

17. The grill cleaner of claim 10 wherein the cleaning component further comprises more than one cable sock crimped to a wire in a longitudinally compressed condition.
